(19) United States
(12) Patent Application Publication
(10) Pub. No.: US 2025/0389237 A1
(43) Pub. Date: Dec. 25, 2025

(54) AIR/STEAM ENGINE AND USE THEREOF

(71) Applicant: Manfred Rapp, Berlin (DE)

(72) Inventor: Manfred Rapp, Berlin (DE)

(21) Appl. No.: 18/869,873

(22) PCT Filed: May 26, 2023
(86) PCT No.: PCT/EP2023/064170

§ 371 Date: Aug. 29, 2025

(30) Foreign Application Priority Data
May 31, 2022 (DE) 102022113676.0
Sep. 8, 2022 (DE) 102022122759.6

(51) Int. Cl. F02M 25/03; F02B 19/14; F02B 19/18; F02B 65/00; F02M 25/022; F02M 31/02; F02P 23/04

(52) U.S. Cl. CPC F02M 25/03; F02B 19/14; F02B 19/18; F02B 65/00; F02M 25/0222; F02M 31/02; F02P 23/04; F02B 2201/02

(57) ABSTRACT

An air-vapor engine which exhibits one or more cylinders and a piston located therein, by which a stroke movement can be performed. Furthermore, the air-vapor engine has an injection nozzle and a prechamber. The prechamber is arranged between the injection nozzle and the cylinder, a fuel fluid is introduced into the prechamber from the injection nozzle. Compressed air from the cylinder can be received by the prechamber. This enables the stroke movement of the cylinder. In addition, the cylinder is connected to a condenser via an outlet valve such that the air-vapor mixture or the vapor of the air-vapor mixture condenses and is present in the condenser as condensate. The condenser and the injection nozzle are in flow connection. This means that the air-vapor engine exhibits a circuit, resulting in efficient operability.

### DESCRIPTION

The invention relates to an air-vapor engine which exhibits one or more cylinders and a piston located therein, from which a stroke movement can be executed. Furthermore, the air-vapor engine comprises an injection nozzle and a prechamber. The prechamber is arranged between the injection nozzle and the cylinder, wherein a fuel fluid can be fed into the prechamber from the injection nozzle. Compressed air from the cylinder can be received by the prechamber, such that an air-vapor mixture is formed inside the prechamber, which can be introduced into the cylinder. This enables the stroke movement of the piston in the cylinder. In addition, the cylinder is connected to a condenser via an outlet valve such that the air-vapor mixture or the vapor of the air-vapor mixture condenses and is present in the condenser as condensate. The condenser and the injection nozzle are in flow connection with each other via a high-pressure pump and a high-pressure tank, such that the fuel fluid from the condenser can return to the injection nozzle via a high-pressure pump and a high-pressure tank. Thus the air-vapor engine exhibits a circuit, resulting in efficient operability.

### BACKGROUND AND PRIOR ART

Since time immemorial, man has endeavored to use energy for a wide variety of applications, especially for locomotion. The steam engine has made a decisive contribution to this. Steam engines are machines that use water vapor to power mechanical devices. In fact, steam engines have been known since ancient times. Modern vapor engines are constituted by heat engines in the form of piston vapor engines. The basic principle of modern vapor engines has not changed. Typically, vapor flows from a boiler through a special control system in the form of a control cylinder into the working cylinder, which contains a working piston. The working piston is moved by the high-pressure vapor. It performs a back and forth movement, which is converted into a rotary movement via a connecting rod.

Today, steam engines are rarely used for transportation. They can still be found on historic railroads (steam locomotives) and in museums. They have been gradually replaced by combustion engines and electric motors since the beginning of the 20th century. However, both combustion engines and electric motors have disadvantages.

Combustion engines cause a high level of air pollution, as exhaust gases, especially exhaust gases that are not climate-friendly, are released directly into the environment during operation. Another disadvantage is the high noise factor and the fact that combustion engines with combustion engine drive systems can only be used indoors to a limited extent.

Electric motors also have a number of disadvantages. Batteries that supply the electricity for the electric motor still have a low power and energy density. The range of the vehicles powered by them is correspondingly short, which limits their usability. This can currently only be countered by using very large and therefore heavy batteries. Another problem is the deterioration in battery performance at low temperatures. For example, batteries for electric motors lose up to approx. 60% of their energy at sub-zero temperatures. In addition, the purchase costs for a means of transportation, such as a car, with an electric motor are around 40%-50% higher than for a car with a combustion engine.

In the prior art, efforts to provide vapor engines are also known. Vapor engines have a similar operating principle to the steam engine. By way of contrast to the classic steam engine, the components are integrated in a housing.

Nowadays, there are only a few vapor engine manufacturers left, for example Spilling Technologies GmbH in Hamburg, which produces stationary vapor engines. From around 1990, IAV GmbH Ingenieurgesellschaft Auto und Verkehr attempted to build a passenger car vapor drive system, the ZERO Emission Drive, but this failed around 2021 due to technical method steps.

An efficient vapor engine that is suitable for mass production and eliminates the disadvantages of the prior art is not currently known.

### OBJECTIVE OF THE INVENTION

The objective of the invention is to eliminate the disadvantages of the prior art of known engines. In particular, an air-vapor engine should be provided which does not emit any or only emits minor pollutant emissions, can be provided and installed at low cost and is suitable for mass application. Furthermore, the air-vapor engine should exhibit a high degree of efficiency and be efficiently suitable for means of transportation and other applications.

### SUMMARY OF THE INVENTION

The objective of the invention is solved by the independent claims. Advantageous embodiments of the invention are disclosed by the dependent claims.

In a first aspect, the invention relates to an air-vapor engine comprising a cylinder and a piston, wherein it is possible for the piston to execute a stroke movement between a top dead center and a bottom dead center within the cylinder, characterized in that the air-vapor engine exhibits an injection nozzle and a prechamber (and/or piston chamber), wherein the prechamber (and/or piston chamber) is present in a flow connection between the injection nozzle and the cylinder and a fuel fluid can be introduced from the injection nozzle into the prechamber (and/or piston chamber) and the fuel fluid in the prechamber (and/or piston chamber) can be converted into a vapor and compressed air from the cylinder can be received into the prechamber, such that an air-vapor mixture is formed within the prechamber and the air-vapor mixture can be introduced into the cylinder, such that the stroke movement of the piston can be effected within the cylinder and the cylinder is present in a flow connection with a condenser, and the cylinder and the condenser are connected via a high-pressure pump and a high-pressure tank to the injection nozzle and the prechamber in a circuit, wherein the air-vapor mixture or the vapor of the air-vapor mixture can be introduced from the cylinder into the condenser and is present in the condenser as condensate and the condensate can be introduced into the injection nozzle via the high-pressure pump and the high-pressure tank.

The air-vapor engine according to the invention has proven to be particularly advantageous in many aspects.

Advantageously, the preferred air-vapor engine is characterized by its freedom from pollutants. The typical gasoline and diesel engines of the prior art emit a considerable amount of pollutants that are dangerous to the health of both humans and other living creatures and make a detrimental contribution to climate change. For example, gasoline and diesel engines emit unburnt hydrocarbons, which are carcinogenic and form part of the well-known smog. The preferred air-vapor engine avoids this by not generating any exhaust pollutants. For example, the preferred air-vapor engine is operated with water vapor as the fuel fluid. This makes a beneficial contribution to the climate, the environment and the health of humans and other living creatures.

The fuel fluid is preferably vaporized within the prechamber or can be introduced into the prechamber as vapor or gas and enters the cylinder as an air-vapor mixture so that the stroke movement of the piston can be effected. Preferably, the cylinder is in flow connection with a condenser, such that the vapor of the air-vapor mixture or the vapor within the condenser is present as a condensate and thus as a liquid. The fuel fluid can preferably return from the condenser to the injection nozzle via the high-pressure pump and the high-pressure tank and thus be reintroduced into the prechamber in the circuit.

Furthermore, the preferred air-vapor engine also offers enormous production efficiency for automobile manufacturers. Thus, automobile manufacturers could advantageously continue to build their existing engines as before, but at a significantly lower cost than the already known engines of the prior art due to the design of the preferred air-vapor engine. Approximately 85 million passenger cars are produced worldwide, and there are currently approximately 500 million existing passenger cars that can be retrofitted with the preferred air-vapor engine particularly easily. Advantageously, known engines, such as electric motors and hydrogen engines of the prior art, will no longer be required. Consequently, large profit margins can be achieved, as the preferred air-vapor engine is an unrivaled product.

The components of the preferred air-vapor engine are sufficiently well known and have proven to be inexpensive. Consequently, the manufacture as such of the preferred air-vapor engine can also be carried out in a simple manner as part of mass production, for example by automobile manufacturers.

Advantageously, the preferred air-vapor engine has a flexible range of applications. Thus, the preferred air-vapor engine can be used in both dynamic and static applications. In the context of the invention, dynamic applications preferably refer to those applications in which a movement is relevant, for example the movement of a means of transportation, such as an automobile. Static applications preferably refer to those applications in which movement is not necessary, for example if the means of transportation remains at rest or the converted mechanical energy is required for a device or a process in which no movement results. Consequently, the preferred air-vapor engine can advantageously be used anywhere for external energy generation.

Terms such as substantially, approximately, about, approx. etc. preferably describe a tolerance range of less than ±40%, preferably less than ±20%, particularly preferably less than ±10%, even more preferably less than ±5% and in particular less than ±1%. “Similar” preferably describes quantities that are approximately the same.

In the context of the invention, the air-vapor engine refers to an engine that requires air and vapor for its operability. The vapor is preferably provided by introducing a fuel fluid into the prechamber via the injection nozzle, e.g. by water and/or carbon dioxide, inter alia. The preferred air-vapor engine within the meaning of the invention preferably comprises a piston in the cylinder, an injection nozzle, a high-pressure pump, a high-pressure tank and a condenser, which are preferably in flow connection with one another in a circuit.

The cylinder preferably refers to a component of the preferred air-vapor engine. The cylinder comprises a casing, which preferably exhibits a cylindrical shape, and a volume located therein. Preferably, a piston is located within the cylinder. The average person skilled in the art will know that the phrase “piston within the cylinder” means that the piston is located within the volume of the cylinder. The cylinder has a top dead center and a bottom dead center. Top dead center and bottom dead center preferably refer to reference regions of the cylinder in which the piston preferably no longer performs a stroke movement. The piston is preferably connected to a connecting rod. The connecting rod preferably forms a connection between the piston and a crankshaft or a crankpin, wherein the crankshaft or the crankpin is used to transmit the stroke movement of the piston, for example for the movement of a tire. At top dead center, the greatest distance between the piston and the crankshaft or the crankpin is preferably present. Correspondingly, the lowest connection between the piston and the crankshaft or the crankpin is preferably present at bottom dead center.

The cylinder preferably exhibits an inlet valve and an outlet valve. The outlet valve is preferably used to control the outlet of the air-vapor mixture from the cylinder. It is therefore preferared that the vapor of the air-vapor mixture or the air-vapor mixture is discharged from the cylinder into the condenser via the outlet valve.

The piston preferably refers to a movable component, wherein the movement of the piston within the cylinder changes the volume of the air contained therein. Preferably, a stroke movement of the piston can be performed within the cylinder. The stroke movement of the piston preferably refers to a substantially vertical movement of the piston between top dead center and bottom dead center.

Preferably, the cylinder is in a flow connection with the prechamber, wherein the prechamber is preferably arranged between the injection nozzle and the cylinder. The prechamber refers to a chamber that comprises a casing and a cavity located therein. Preferably, the prechamber exhibits a smaller volume than the volume of the cylinder.

Preferably, the fuel fluid can be introduced from the injection nozzle into the prechamber, preferably at such a temperature within the prechamber that the fuel fluid vaporizes. Accordingly, the fuel fluid is preferably present as vapor after introduction into the prechamber, wherein the vapor preferably forms substantially immediately after introduction (injection).

The compressed air preferably refers to the air that substantially corresponds to the entire stroke volume and is introduced into the prechamber. Preferably, the compressed air in the prechamber also exhibits an increased pressure and temperature.

Preferably, compressed air from the cylinder can be received in the prechamber such that an air-vapor mixture is formed inside the prechamber. Preferably, in order to provide the air-vapor mixture, the fuel is first introduced into the prechamber.

In preferred embodiments, the prechamber is in the form of a swirl chamber. Advantageously, the swirl chamber results in particularly good mixing of the compressed air from the cylinder, which enters the swirl chamber, and the fuel fluid. Preferably, the swirl chamber is spherical or cylindrical in shape. It is also preferred that the swirl chamber is connected to the cylinder via a tangentially discharging channel. The compressed air is preferably pressed out of the cylinder into the swirl chamber and set in rotation due to the tangential opening of the channel. The fuel fluid is introduced from the injection nozzle into the swirl chamber in the direction of the air movement. The centrifugal effect creates an air-vapor mixture with a particularly suitable mixture, such that the stroke movement of the piston can be achieved particularly effectively. In particular, the piston can be moved from top dead center back in the direction of bottom dead center with an additionally increased pressure.

In preferred embodiments, the prechamber exhibits an inlet and outlet valve, wherein the air-vapor mixture enters the cylinder from the prechamber via the inlet and outlet valve. Preferably, the inlet and outlet valve is designed as a control valve. Advantageously, the flow rate of the air-vapor mixture from the prechamber into the cylinder can be regulated continuously by the inlet and outlet valve of the prechamber, in particular as a control valve. The inlet/outlet valve can preferably be adjusted mechanically or electrically.

Preferably, the fuel fluid can be introduced into the prechamber from the injection nozzle. The injection nozzle preferably refers to an apparatus with which the fuel fluid is introduced into the prechamber. Known injection nozzles from the prior art can be used for this purpose, preferably one or more piezo injection nozzles.

A piezo injection nozzle preferably refers to an injection nozzle that uses the piezoelectric effect to inject the fuel fluid into the prechamber. Preferably, a piezo injection nozzle comprises a plurality of piezo elements in the form of piezo layers, which enable the injection of the fuel fluid into the prechamber by providing an electrical voltage.

It may also be preferred to fit injection nozzles that introduce the fuel fluid into the prechamber by a mechanism other than the piezoelectric effect, for example by magnetic, electromagnetic or mechanical means.

By introducing the fuel fluid from the injection nozzle into the prechamber at a sufficient pressure, the pressure inside the prechamber is increased, but the temperature inside the prechamber is reduced. This results in particular from the vaporization of the fuel fluid within the prechamber. Due to increase in the pressure, the piston of the cylinder can effect a stroke movement at a particularly high pressure.

The water from the preheated high-pressure tank preferably reaches the piezo injection nozzle at approx. 98° C. and approx. 2600 bar. The fluid injected into the prechamber through the piezo injection nozzle has a temperature of preferably approx. 300-400° C., such that the finely atomized water is immediately converted into vapor by a sudden phase transition. The prechamber preferably already contains compressed air from the compression stroke of the cylinder at a temperature of approx. 900° C. and a pressure of approx. 60 bar (diesel process). As the fluid from the piezo injection nozzle impinges as vapor on the compressed air from the cylinder, a reversal process immediately occurs in the prechamber, i.e. the compressed air lowers the temperature from preferably approx. 900° C. to 350° C. and the pressure increases from preferably approx. 60 bar to approx. 200 bar. This now highly pressurized air-water vapor mixture enters the cylinder in a controlled manner from the prechamber, where it expands and performs work. The energy generation process described can also preferably take place with other types of injection nozzles.

In further preferred embodiments, there are 2 or more injection nozzles that introduce fuel fluid into the prechamber. The advantage of this is that the increased quantity of fuel fluid introduced into the prechamber results in higher pressure generation with a corresponding reduction in the temperature inside the prechamber.

Preferably, the fuel fluid is introduced into the prechamber in a finely atomized phase, i.e. in the form of atomized particles. The particles of the fuel fluid are present as fine droplets. Advantageously, this results in particularly rapid vaporization of the fuel fluid and therefore faster generation of the air-vapor mixture within the prechamber and therefore also a faster increase in pressure within the prechamber.

In further preferred embodiments, the fuel fluid is introduced into the prechamber at an elevated temperature, for example in a temperature range between approximately 50° C.-150° C., preferably at approximately 100° C.

The fuel fluid preferably refers to a fluid that acts as a fuel in order to exploit the usability of the preferred air-vapor engine. The fuel fluid is therefore preferably a fuel in fluidic form, i.e. it is present as a liquid or as a gas or vapor. Preferably, the fuel fluid is water or water vapor. Preferably, the fuel fluid is present in the injection nozzle and is introduced into the prechamber for vaporization.

Preferably, an air-vapor mixture comprising compressed air from the cylinder and the fuel fluid in vapor form is formed inside the prechamber, which is returned to the cylinder and converted into the stroke movement of the piston. A condenser is preferably in flow connection with the cylinder. This allows the vapor of the air-vapor mixture or the air-vapor mixture to enter the condenser. By reducing the temperature accordingly, the vapor or the air-vapor mixture condenses such that it is present inside the condenser as a condensate or as a liquid. Since the condenser is preferably also in flow connection with the high-pressure pump, the high-pressure tank and the injection nozzle, and the fuel fluid can therefore be fed into the injection nozzle as condensate, a circuit exists.

The circuit in the context of the invention preferably means that the fuel fluid can be brought to the injection nozzle substantially on a repeating basis. Thus, the fuel fluid is present within the prechamber and the cylinder as vapor, passes from the cylinder into the condenser, where it is present as condensate, i.e. as a liquid, and can then be transferred to the injection nozzle.

Preferably, the high-pressure pump can convey the fuel fluid at a high pressure within the air-vapor engine, for example into the high-pressure tank. The high-pressure tank preferably refers to a container that is capable of storing the fuel fluid at the correspondingly high pressure. During operation of the preferred engine, the fuel fluid can preferably enter the injection nozzle, for example from the high-pressure tank.

Preferably, the fuel fluid can be fed as condensate from the condenser into the high-pressure pump and then into the high-pressure tank, wherein preferably the fuel fluid can be fed from the high-pressure tank into the injection nozzle.

The preferred components of the air-vapor engine according to the invention are preferably in flow connection with one another. In the context of the invention, the flow connection preferably means that a conduit for the fuel fluid is made possible. The flow connection can, for example, be provided by a fluid line, such as a pipe or hose line.

The preferred air-vapor engine does not violate the 1st and/or 2nd law of thermodynamics, since substances and/or energy are supplied to enable the preferred air-vapor engine to function. For example, a battery is required to enable the movement of the piston. Furthermore, an electric current is preferably required to enable the functionality of components such as the injection nozzle, the inlet and outlet valve, a high-pressure pump, the heating of the prechamber, etc.

The preferred air-vapor engine is based in particular on the known diesel process. A substantial advantage of the preferred air-vapor engine is that it enables (lightning-fast) vapor generation in the prechamber in the millisecond range.

In the prior art, there are internal combustion reciprocating piston engines as gasoline and diesel engines. Both types draw in air, compress this air, add fuel and ignite the fuel, resulting in an increase in pressure, which leads to output through expansion. The petrol engine (gasoline engine) must ignite the fuel-air mixture externally (Otto process), while the diesel engine works with self-ignition (diesel process).

The new invention, the preferred air-vapor engine, is not an internal combustion engine, but can use the same engines and operates according to a completely new operating method. It can be used with 2 and 4-stroke engines, but also with all other combustion engines. The preferred air-vapor engine combines the gasoline and diesel processes and operates according to a boundary pressure process, which has not yet been achieved in the prior art. The advantageous result is a considerably better overall efficiency.

The preferred air-vapor engine is capable of drawing in air from the atmosphere, like the gasoline and diesel engines, and compressing the air drawn in at a compression ratio of approx. 24:1 (gasoline 10:1, diesel 24:1). In this highly compressed air in the diesel process, which generates a pressure of approx. 60 bar and a temperature of approx. 900° C., the preferred air-vapor engine injects a medium (the fuel fluid), e.g. distilled water, CO₂ or other suitable media. Shortly before top dead center (TDC), finely atomized, highly pressurized water (i.e. water with an increased pressure) is injected into the cylinder, for example at a pressure of approx. 2600 bar (e.g. through a piezo injection nozzle), directly into the cylinder, into a prechamber or swirl chamber.

The piston can preferably exhibit a spherical chamber in the piston surface, in which the air-vapor mixture is injected directly and is advantageously very well swirled. However, classic prechambers and swirl chambers can also be used.

The fuel fluid, e.g. water, is compressed with a high-pressure pump, e.g. to approx. 2600 bar, and preheated in the high-pressure tank at a temperature of approx. 95-98° C. and injected with an injection nozzle with finely atomized water droplets, preferably directly into the cylinder, directly into the piston chamber or into a separate prechamber or swirl chamber. Preferably, an immediate phase transition takes place in the chambers, in particular from the water state to vapor formation.

The already highly compressed air in the cylinder at TDC fills up preferably in the chamber (e.g. at approx. 60 bar and approx. 900° C.), then the water injection takes place and undergoes a lightning-fast phase transition and a reversal process in the millisecond range. An air-vapor mixture is created immediately, i.e. the air temperature in the prechamber drops in a controlled manner, e.g. from approx. 900° C. to approx. 300° C. and the pressure increases from approx. 60 bar to approx. 200 bar or higher. This occurs in a ratio of approx. 3:1 and approx. 1:3. The temperatures and pressure are controlled in the boundary pressure process.

The well-mixed, highly pressurized air-vapor mixture expands preferably in the cylinder and performs work. Shortly before top dead center (TDC), the expanded air-vapor mixture is preferably fed into a condenser via a normal outlet valve, where the air is preferably separated from the water. The water is then preferably compressed to approx. 2600 bar via a high-pressure pump and stored in a preheated high-pressure tank (approx. 95-98° C.). From here, the highly compressed fuel fluid (e.g. hot water) preferably reaches the injection nozzle and the operating process is preferably recirculated as described above.

This means that the water tank advantageously does not need to be refilled; in particular, it only needs to be topped up as a result of any leaks in the system. The water is preferably supplied in a circulation process. The water is preferably distilled.

The particular physical effect of the air-vapor engine results preferably from the high compression (diesel principle) of the intake air, in particular at a compression ratio of approx. 24:1, wherein the temperature of the intake air is preferably approx. 900° C. and the pressure approx. 60 bar. In this hot air, finely atomized, preheated (distilled) water is preferably injected into the prechamber through the injection nozzle (instead of fuel) at a pressure of preferably approx. 2600 bar, which mixes intensively with the hot air and results in a temperature reduction from approx. 900° C. to approx. 300° C. and a pressure increase from approx. 60 bar to approx. 200 bar due to a physical reversal process (and this without combustion). This now highly pressurized air-vapor mixture expands preferably in the cylinder and performs work there. All the functional effects described take place within the framework of physical laws and result advantageously in an economical, ecological and pollutant-free new engine drive concept, which solves a number of current problems in vehicle and engine technology.

The preferred air-vapor engine generates the energy preferably by an automatic reversal process of lowering the temperature of the intake air and increasing the pressure of the air-vapor mixture. The thus highly pressurized air-vapor mixture is preferably fed from the prechamber into the cylinder, where it expands and performs work. The same process is preferred for direct injection into the piston chamber.

This advantageously results in a simple, emission-free engine principle, very low general operating costs, an extremely high power density, low-noise operation, a operating process in a circulation system, minimal maintenance, low permanent costs and a favorable purchase price.

Prior art combustion engines, on the other hand, have to mix expensive fuel with the compressed air for the same process and ignite it in order to increase the pressure of the fuel-air mixture in the cylinder with all the known major environmentally harmful disadvantages of today's combustion technology with considerably higher general costs and the major known environmental damage from exhaust gas.

The complete phasing out of today's disadvantageous combustion engine technology is already foreseeable due to competition from very expensive electric vehicles or other expensive alternative drive systems such as hydrogen engines, hybrid drives etc. However, the total pollutant production of all alternative vehicles in the value creation process is very high for these new drive systems. However, this is generally not communicated directly to society and consumers, as most of the pollutant generation of electricity for electric vehicles is currently shifted to the large power plants and the overall electric drive system of the vehicles with battery and control technology is complicated, very complex and very expensive. Battery explosions are also known to occur in vehicles with batteries when stationary or in accidents.

The entire hydrogen production process for hydrogen engines is even more complex and dangerous, as there is no complex, very expensive and problematic global infrastructure. It is known that in Germany alone, costs of around several hundred billion euros are incurred, which is also not communicated directly to society. In addition, the highly pressurized hydrogen, which is necessarily stored in large quantities everywhere, is highly explosive. The general accident safety of expensive hydrogen is currently still very questionable. In the event of serious accidents, explosions and/or fires are difficult or impossible to prevent. The maintenance effort is very complicated and highly costly.

Consequently, the preferred air-vapor engine achieves a considerable improvement over the already known prior art.

In a further preferred embodiment, the air-vapor engine is characterized in that the condenser, the high-pressure pump and/or the high-pressure tank are data-connected to a control unit.

In a further preferred embodiment, the air-vapor engine is characterized in that the condenser, the high-pressure pump, the high-pressure tank and/or the injection nozzle are data-connected to a control unit, wherein the control unit is preferably data-connected to further components, wherein the further components are selected from a group comprising a laser and/or an inlet and outlet valve (control valve).

In the context of the invention, “data-connected” preferably means that an exchange of data between the control unit and one or more of these components is possible. In this context, data preferably refers to commands for executing functions and/or for providing settings for the one or more components. In particular, the settings may relate to settings of flow parameters of the fuel fluid. For example, it may be preferred to regulate the flow rate of the fuel fluid flowing from the condenser. It may also be preferred, for example, to use the control unit to adjust the pressure of the high-pressure pump and/or monitor the high-pressure tank.

A control unit preferably refers to a unit that is configured to read, receive, send and/or evaluate data. Thus, the control unit is preferably a data processing unit. A control unit may preferably be selected from a group comprising an integrated circuit (IC), an application-specific integrated circuit (ASIC), a programmable logic device (PLD), a field programmable gate array (FPGA), a processor or process unit, a microprocessor, a microcomputer, a programmable logic controller and/or any other electronic, preferably programmable, circuit.

The control unit may preferably also comprise a memory unit and/or communication unit. A memory unit allows the backup and/or temporary storage of data. Non-limiting examples of memories, preferably semiconductor memories, are volatile memories (RAM) memories or non-volatile memories, such as ROM memories, EPROM memories, EEPROM memories or flash memories and/or other memory technologies. In the context of the invention, a communication unit preferably refers to a device for transmitting, in particular for sending and/or receiving, data. The transmission is preferably carried out by directed or non-directed electromagnetic waves, wherein the range of the frequency band used can vary from a few Hertz (low frequency) to several hundred Terahertz, depending on the application and the technology used, wherein the following data transmission methods can be used, for example: Bluetooth, WLAN, ZigBee, NFC, Wibree or WiMAX in the radio frequency range as well as IrDA and optical radio relay (FSO) in the infrared or optical frequency range.

In further preferred embodiments, the control unit is present as or in combination with a sensor. The sensor is preferably arranged to measure parameters of one or more of the components comprising condenser, high-pressure pump and/or high-pressure tank as well as one or more or all data relevant to the operation of the preferred air-vapor engine.

In a further preferred embodiment, the air-vapor engine is characterized in that the air-vapor engine exhibits a pressure sensor and/or a temperature sensor, wherein the pressure sensor and/or the temperature sensor are preferably data-connected to a control unit.

The pressure sensor can be attached to preferred components of the air-vapor engine. The temperature sensor can also be attached to preferred components of the air-vapor engine. Advantageously, by attaching the pressure or temperature sensor, the pressure or temperature of the component to which the corresponding sensor is attached can be measured and thus also reliably monitored.

In further preferred embodiments, the air-vapor engine may exhibit a plurality of pressure or temperature sensors, for example attached to different components, in order to measure and/or monitor the plurality of components.

In particularly preferred embodiments, one or more pressure and temperature sensors are present in combination. Furthermore, it is preferred that the pressure and temperature sensors are data-connected to the control unit, i.e. exhibit a data connection with the control unit. Advantageously, the control unit can be used to operate and/or regulate the operation of components using the pressure and temperature readings from the sensors.

For example, it may be preferred for a temperature sensor and a pressure sensor to be attached to the prechamber. These are connected to a control unit. Preferably, further components of the air-vapor engine, for example (but not limited to) an inlet and outlet valve, a laser, a prechamber piston, an injection nozzle and/or the high-pressure pump, can be operated taking into account the pressure and temperature values within the prechamber.

In a further preferred embodiment, the air-vapor engine is characterized in that a prechamber piston is present within the prechamber, wherein the prechamber piston is connected to the piston in the cylinder, such that a stroke movement can be executed by the prechamber piston within the prechamber.

In a further preferred embodiment, the air-vapor engine is characterized in that a prechamber piston is present within the prechamber, wherein the prechamber piston is connected to the piston in the cylinder, such that a stroke movement can be performed by the prechamber piston within the prechamber, as a result of which a higher pressure can be generated in the prechamber.

The presence of a prechamber piston additionally displaces the volume of the vapor or air-vapor mixture within the prechamber. As a result, the pressure of the vapor or air-vapor mixture in the prechamber is also significantly increased. By increasing the pressure within the prechamber, a more intense pressure of the air-vapor mixture can advantageously be transferred into the cylinder and consequently the kinetic energy of the piston within the cylinder can also be increased.

In the context of the invention, the prechamber piston preferably refers to a piston that is located inside the prechamber. Preferably, the prechamber piston is connected to the piston inside the cylinder such that both pistons perform a stroke movement.

In a further preferred embodiment, the air-vapor engine is characterized in that the prechamber piston exhibits a drive, whereby the drive can preferably be operated mechanically or electromagnetically. Advantageously, the volume displacement of the vapor or air-vapor mixture in the prechamber can be configured particularly easily and precisely with the aid of a mechanical or electromagnetic drive. This results in variability with regard to the possible selection and adjustment of the pressure within the prechamber, such that a stroke movement of the piston can be carried out particularly efficiently. As a result, a variable higher pressure in the prechamber can be advantageously regulated via the preferred control unit.

In the context of the invention, a mechanical drive preferably refers to a drive by mechanical means. Preferably, in a mechanical drive, the torque is transmitted with the aid of transmission means such as clutches and/or belt drives. An electromagnetic drive preferably refers to a drive using electromagnetic means.

In preferred embodiments, the prechamber piston is present in combination with the inlet and outlet valve of the prechamber. In particularly preferred embodiments, the inlet and outlet valve is present in combination with the prechamber piston and a drive for the prechamber piston, for example a mechanical or electromagnetic drive. In further preferred embodiments, the drive enables the prechamber piston to perform a lateral movement. A lateral movement of the prechamber piston 35 preferably means a movement in lateral directions within the prechamber.

In a further preferred embodiment, the air-vapor engine is characterized in that the fuel fluid is selected from a group comprising water and/or carbon dioxide and/or other suitable fluids. Advantageously, water and/or carbon dioxide is available in almost unlimited quantities in nature, such that, in contrast to prior art engines, resources are saved. Furthermore, water in particular is characterized by its climate friendliness, such that the preferred air-vapor engine makes a beneficial contribution to the climate and the environment. Advantageously, the emission of pollutants into the environment is avoided. In further preferred embodiments, the water may be distilled water.

Water has also proven to be extremely useful for the operation of the preferred air-vapor engine. Water exhibits thermodynamic properties, e.g. a suitable enthalpy of vaporization, that are suitable for causing a sufficient pressure increase and temperature reduction within the prechamber. Preferably, the water is distilled (distilled water).

In a further preferred embodiment, the air-vapor engine is characterized in that the prechamber is functionally connected to a heating element, preferably a glow plug. In further preferred embodiments, other heating systems and/or heating elements can also exhibit an active connection with the prechamber.

Advantageously, the installation of a heating element ensures that the preferred air-vapor engine functions reliably even at low ambient temperatures. It is also advantageous that the installation of a heating element entails a particularly homogeneous heat distribution within the prechamber. This enables faster and spatially symmetrical vaporization of the fuel fluid within the prechamber.

A heating element preferably refers to a device through which heat can be transferred. “Functionally connected” here preferably means that there is a connection between the heating element and the prechamber such that the heat can be transferred from the heating element to the prechamber. It may therefore be preferred to place the heating element directly on, on top of or in the prechamber. It may also be preferred to connect the heating element to the prechamber via heat pipes.

In preferred embodiments, the heating element is a glow plug. In the prior art, glow plugs have proven to be particularly useful and reliable for starting the engine at low temperatures and for low-noise and low-emission operation during the warm-up phase. Glow plugs are also advantageously ideally suited for use in the preferred air-vapor engine.

In a further preferred embodiment, the air-vapor engine is characterized in that the high-pressure tank is functionally connected to a heating element. Advantageously, this also allows the high-pressure tank to be set to a desired temperature in order to ensure optimum pressure and/or temperature of the fuel fluid, particularly within the high-pressure tank.

In a further preferred embodiment, the air-vapor engine is characterized in that the air-vapor engine exhibits a laser, wherein the prechamber can be irradiated by the laser, wherein the prechamber preferably exhibits a prechamber piston and/or a drive for the prechamber piston. Preferably, the laser beams are emitted from the laser inwards into the prechamber.

The installation of the laser has proven to be particularly advantageous in that the laser beams emitted by the laser can achieve particularly rapid vaporization of the injected propellant fluid within the prechamber in the millisecond range. Furthermore, the installation of a laser is particularly easy to implement. The laser can preferably emit pulsating or continuous laser beams.

The preferred laser can be used in preferred embodiments of the invention. Thus, it may be preferred to position the laser such that the laser irradiates the prechamber, the swirl chamber and/or the piston chamber with laser beams. The laser can preferably irradiate the prechamber in the embodiment in which no prechamber piston is introduced within the prechamber. The laser can preferably irradiate the prechamber in the embodiment in which a prechamber piston is introduced within the prechamber. The laser can preferably irradiate the prechamber in the embodiment in which a prechamber piston with a drive is present.

For example, a laser is preferably present that irradiates the prechamber such that a particularly rapid phase transformation of the fuel fluid within the prechamber is made possible. Preferably, the prechamber can exhibit a drive for a prechamber piston that performs a lateral movement, for example. Furthermore, it may be preferred that the prechamber exhibits an inlet and outlet valve as a control valve in order to regulate the flow rate of the air-vapor mixture from the prechamber into the cylinder. In particular, the advantages of the laser, the inlet and outlet valve (as a control valve) and/or the drive of the prechamber piston can be combined to enable particularly efficient functional operation. The resulting efficiency is higher than could be expected from the effects of the individual components, such that a synergistic effect is achieved. It may be preferred to install temperature and/or pressure sensors that can be attached to the prechamber (not limited to this), for example, and exhibit a data connection with the control unit. Advantageously, this ensures a particularly secure process sequence of the preferred air-vapor engine. In further preferred embodiments, the laser can also be used if the prechamber has an outlet and inlet valve (as a control valve). In further preferred embodiments, the laser can be used if the prechamber does not exhibit an inlet and outlet valve.

Instead of or in addition to a prechamber, it may also be preferred to provide a piston chamber. In a further preferred embodiment, the air-vapor engine is therefore characterized in that the air-vapor engine exhibits a piston chamber.

In particular, the prechamber can be omitted if a piston chamber is used. By omitting the prechamber, the vapor formation and vapor generation can be shifted to the piston chamber. The advantage of this variant is direct vapor formation in the cylinder chamber. The cost savings of the inlet and outlet valve (as a control valve), the drive of the prechamber piston and the laser also represent an advantage. With this embodiment, all existing combustion engines can be converted easily and cost-effectively.

In a further preferred embodiment, the air-vapor engine is characterized in that the fuel fluid can be introduced into the prechamber from the injection nozzle at a pressure of between 2000 bar-3000 bar, preferably between 2200 bar-2800 bar, particularly preferably between 2400 bar-2600 bar, most preferably between 2500 bar-2700 bar.

The aforementioned values for the pressure have proven to be advantageous in that, on the one hand, they caused a sufficient increase in pressure within the prechamber and, on the other hand, were particularly easy to implement in the context of the invention.

The aforementioned values for the pressure for the compressed air have proven to be particularly advantageous for high energy conversion and continuous operation of the preferred engine.

In a further preferred embodiment, the air-vapor engine is characterized in that the air-vapor engine can be operated using a four-stroke mechanism or a two-stroke mechanism. In particular, the four-stroke mechanism and the two-stroke mechanism refer to mechanisms from the prior art.

Advantageously, common engines of the prior art are thus required to provide the preferred air-vapor engine, in particular with an injection nozzle and a prechamber. In further preferred embodiments, the preferred air-vapor engine can be operated as a piston engine, for example as described in patent EP 2603667 B1 (or official file number: EP 3143258 B1).

In particularly preferred embodiments, the preferred air-vapor engine is operable by means of a four-stroke mechanism. The four-stroke mechanism preferably refers to a operating process that is executable during an operation of the preferred air-vapor engine.

The four-stroke mechanism preferably exhibits 4 operating steps, which can also be referred to as strokes. The preferred four-stroke mechanism preferably comprises the following 4 strokes:
1st stroke (intake): The piston moves from top dead center to bottom dead center, drawing in air from the atmosphere during this stroke movement.
2nd stroke (compression): The piston moves from bottom dead center back to top dead center, wherein the air is compressed during this stroke movement (compressed air) and there is an increase in pressure. For example, the pressure can be approx. 60 bar and the temperature approx. 900° C. The compressed air enters the prechamber. Shortly before the piston reaches top dead center of the cylinder, the fuel fluid is preferably introduced into the prechamber, for example at a pressure of approx. 2600 bar. The introduced fuel fluid is vaporized immediately after being introduced into the prechamber, such that an air-vapor mixture forms in the prechamber. This increases the pressure, for example to approx. 220 bar, while the temperature drops, for example to approx. 370° C.
3rd stroke (work): The piston is at top dead center. The air-vapor mixture is blown from the prechamber into the cylinder and expands in the cylinder, and performs work until bottom dead center.
4th stroke (exhaust): The piston moves from bottom dead center back to top dead center. The air-vapor mixture is pushed into the condenser and expands. The air-vapor mixture condenses, wherein the vapor in particular is separated from the air-vapor mixture and is present in the condenser as condensate and the air is discharged into the atmosphere. The condensate (the fuel fluid) returns to the circuit, for example to the high-pressure pump, to the high-pressure tank and then back to the injection nozzle.

In particular, the four-stroke mechanism according to the prior art of reciprocating piston technology has proven to be advantageous when using the preferred air-vapor engine in means of transportation.

In a further aspect, the invention relates to the use of a preferred air-vapor engine for converting energy into mechanical energy, preferably into kinetic energy within a means of locomotion. In particular, in the context of the invention, energy conversion means that the thermal energy, preferably generated in the prechamber, can be converted into kinetic energy, for example for a means of locomotion.

The conversion of energy into mechanical energy comprises the ability to perform mechanical work based on the position or movement of a component of the air-vapor engine, preferably the piston. In particular, the stroke movement of the piston in the cylinder moves a connecting rod such that the mechanical energy can be transmitted.

Preferably, the preferred air-vapor engine is used to convert energy into kinetic energy, which is particularly suitable for use in means of transportation. A means of transportation preferably refers to a device that can be used to move people and/or goods, e.g. automobiles in the form of passenger cars, trucks, motor homes, watercraft such as boats, ships, trains, aircraft and/or steam turbines, etc.

In further preferred embodiments, the preferred air-vapor engine can also be used in any static application where appropriate, for example for providing energy in houses, apartments, etc.

In a further aspect, the invention relates to the use of the air-vapor engine for operating an air conditioning compressor. Advantageously, the preferred air-vapor engine can be used as an air conditioning compressor according to the prior art with a corresponding temperature, pressure and/or volume control in the prechamber.

The aspects according to the invention will be explained in more detail below using examples, without being limited to these examples.

### FIGURES

### Brief Description of the Figures

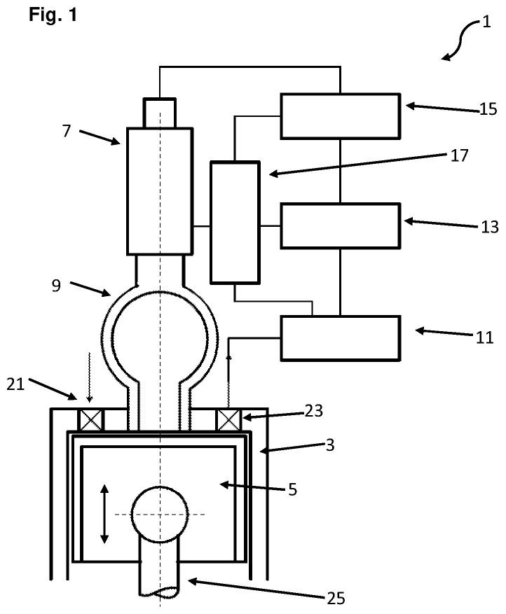

FIG. 1 Schematic representation of a preferred embodiment of a preferred air-vapor engine—basic representation of the air-vapor engine

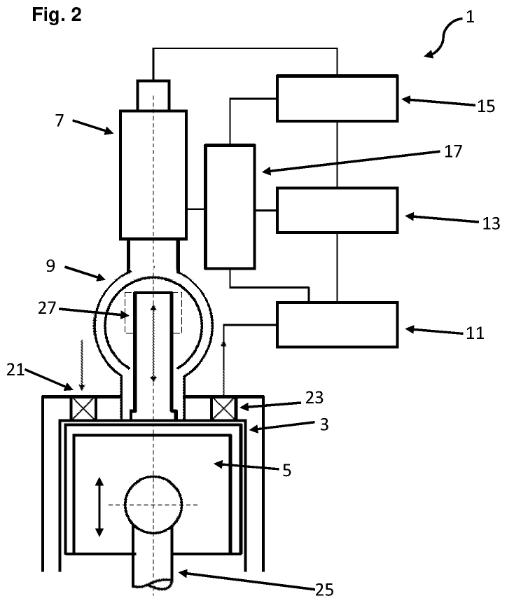

FIG. 2 Further schematic representation of a further preferred embodiment of a preferred air-vapor engine—representation of a unit comprising a piston and a prechamber piston

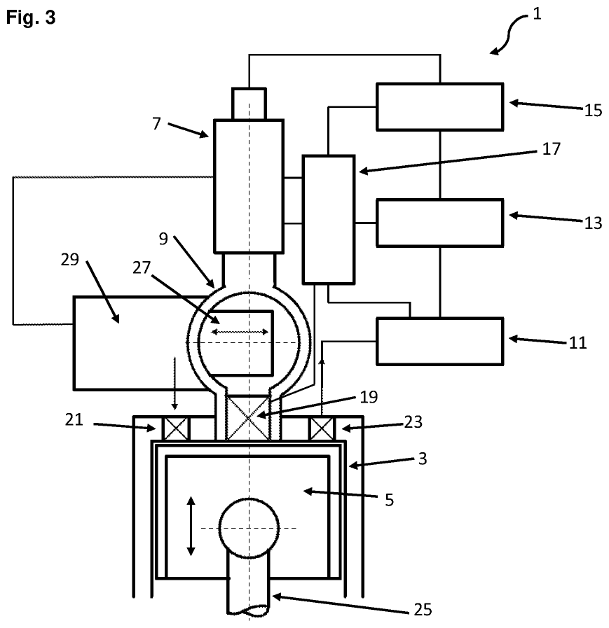

FIG. 3 Further schematic representation of a further preferred embodiment of a preferred air-vapor engine comprising a drive for a prechamber piston in the prechamber

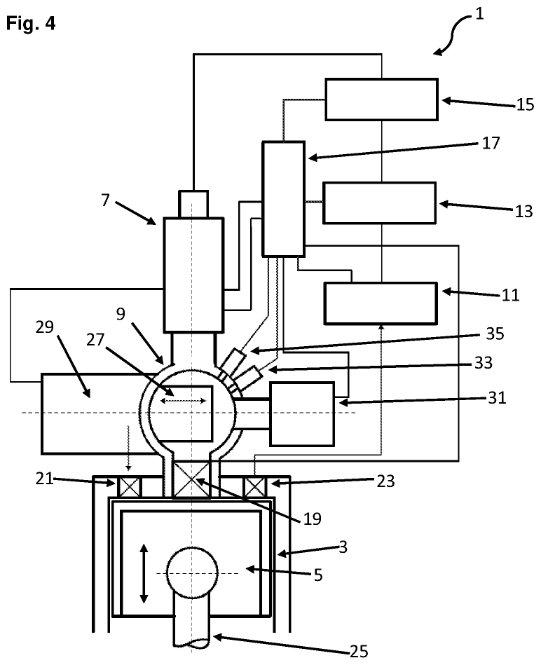

FIG. 4 Further schematic representation of a further preferred embodiment of a preferred air-vapor engine comprising a laser on the prechamber with measuring sensors and a drive for the prechamber piston in the prechamber

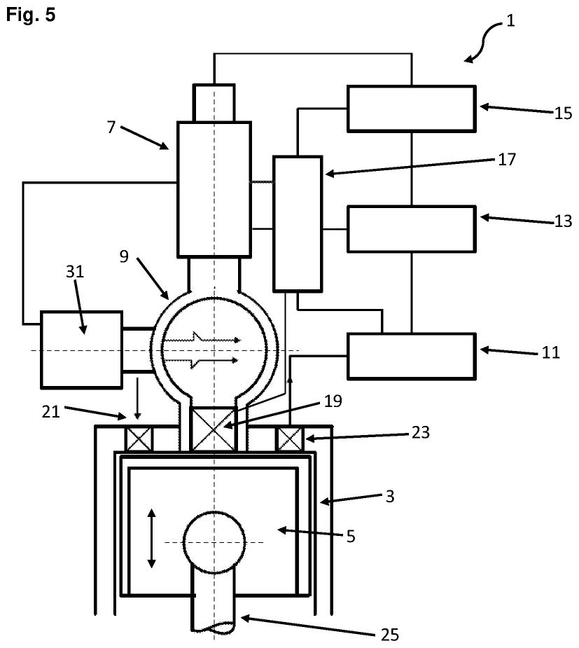

FIG. 5 Further schematic representation of a further preferred embodiment of a preferred air-vapor engine comprising a laser on the prechamber.:

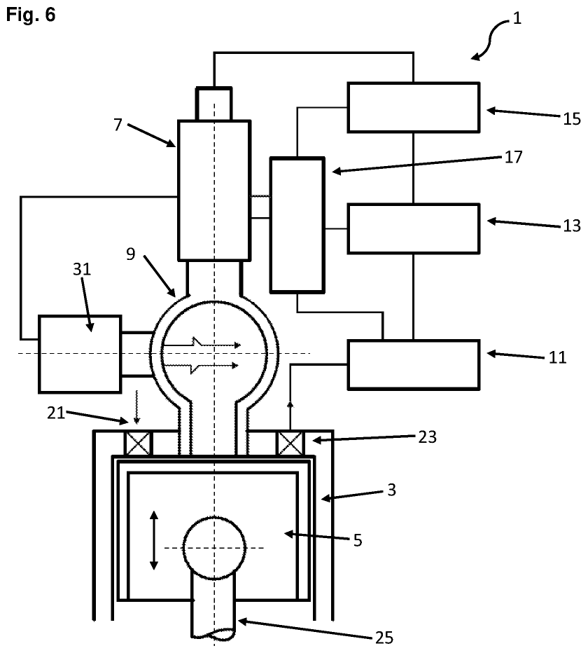

FIG. 6 Further schematic representation of a further preferred embodiment of a preferred. air-vapor engine comprising a laser on the prechamber without inlet and outlet valve

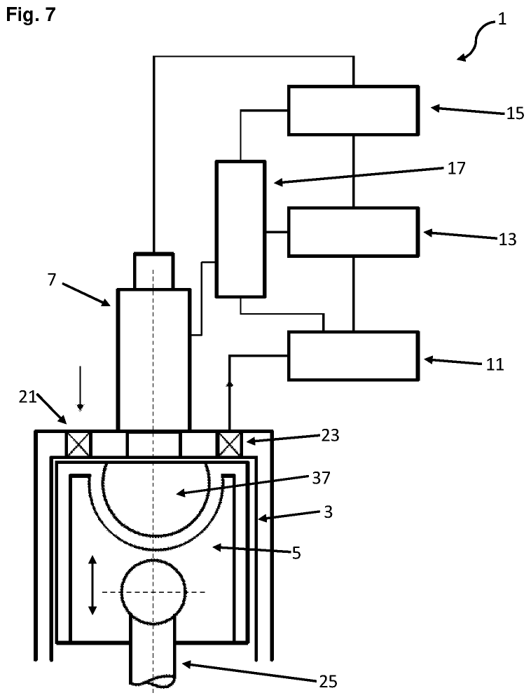

FIG. 7 Further schematic representation of a further preferred embodiment of a preferred air-vapor engine comprising a piston chamber in the piston without inlet and outlet valve

### DETAILED DESCRIPTION OF THE FIGURES

FIG. 1 is a schematic representation of a preferred embodiment of an air-vapor engine 1.

The air-vapor engine comprises a cylinder 3 and a piston 5. The piston can perform a stroke movement between bottom dead center and top dead center of the cylinder 3. The stroke movement of the piston 5 and a connecting rod 25 is illustrated by the arrow symbol (pointing upwards and downwards). Furthermore, the air-vapor engine 1 exhibits an injection nozzle 7, which is configured as a piezo injection nozzle 7, and a prechamber 9. The prechamber 9 is present between the piezo injection nozzle 7 and the cylinder 3, wherein these are in flow connection with each other. A fuel fluid can be introduced from the piezo injection nozzle 7 into the prechamber 9. The prechamber exhibits a temperature such that the fuel fluid in the prechamber vaporizes and the fuel fluid is therefore present in the prechamber as vapor. Compressed air can be received from the cylinder 3 by the prechamber 9, such that an air-vapor mixture forms inside the prechamber 9. The air-vapor mixture can be introduced into the cylinder 3 such that the stroke movement of the piston 5 can be effected within the cylinder 3. This can be shown, for example, by a downward movement from top dead center in the direction of bottom dead center.

The cylinder comprises an inlet valve 21 and an outlet valve 23, wherein the outlet valve 23 is connected to a condenser 11. The air-vapor mixture condenses, wherein the vapor in particular is present as condensate in the condenser 11. The condensate can then be fed from the condenser 11 to a high-pressure pump 13, then into a high-pressure tank 15 and then back into the injection nozzle 7. This means that the injection nozzle 7, the prechamber 9, the cylinder 3, the condenser 11, the high-pressure pump 13 and the high-pressure tank 15 are in a circuit and are connected to each other in a flow connection. A cycle can thus be performed by the air-vapor engine 1.

The air-vapor engine 1 advantageously does not emit any pollutants, such that a significant improvement over the prior art is achieved. The air-vapor engine 1 can, for example, be operated with water or water vapor and other suitable fluids as the fuel fluid. As a result, an advantageous contribution to the climate and the environment is achieved.

Furthermore, the preferred air-vapor engine 1 is also extremely efficient for automobile manufacturers in terms of the development and production of automobiles. The existing engines can be provided as before, but the design of the preferred air-vapor engine 1 makes them significantly cheaper than the already known engines of the prior art. Approximately 85 million passenger cars are produced worldwide, and there are currently approximately 500 million existing passenger cars, which can be integrated particularly easily with the preferred air-vapor engine 1. Advantageously, known engines, such as electric and hydrogen engines of the prior art, are no longer required. Therefore, large profit margins can be achieved, as the air-vapor engine 1 is an unrivaled product.

The components of the preferred air-vapor engine 1 are sufficiently well known and have proven to be inexpensive. Thus, the production as such of the preferred air-vapor engine 1 can also be carried out in a simple manner as part of mass production, for example by an automobile manufacturer. The air-vapor engine 1 is also suitable for static applications and offers an efficient way of providing energy.

The prechamber 9 exhibits an inlet and outlet valve 19. The air-vapor mixture from the prechamber 9 enters the cylinder 3 via the inlet and outlet valve 19. The inlet and outlet valve 19 is designed as a control valve. Advantageously, the flow rate of the air-vapor mixture from the prechamber 9 can be regulated by the inlet and outlet valve 19 of the prechamber 9, in particular as a control valve; in particular, stepless regulation is possible. The inlet and outlet valve 19 can be adjusted both mechanically and electrically.

The high-pressure pump 13 can transport the fuel fluid at a high pressure within the air-vapor engine 1, in particular into the high-pressure tank 15. The fuel fluid can be reintroduced into the injection nozzle 7 from the high-pressure tank 15.

Furthermore, it is shown that the high-pressure tank 15, the high-pressure pump 11 and the condenser 11 are data-connected to a control unit 17. In further preferred embodiments of the air-vapor engine 1, in which components such as an inlet and outlet valve 19, a drive 29 of the prechamber piston 27, a laser 31, a pressure sensor 33 and/or a temperature sensor 35 are present, these can also be connected to the control unit 17 (see explanations in the further figure descriptions). The data connection allows data to be exchanged between the control unit 17 and one or more of these components. In this way, commands for executing functions and/or for providing settings for the one or more components can be adapted. In particular, the settings may relate to settings of flow parameters of the fuel fluid. For example, it may be preferred to regulate the flow rate of the fuel fluid from the condenser 11. In embodiments in which the flow rate is regulated, a flow meter that can measure the flow rate of the fuel fluid can also be fitted. The pressure of the high-pressure pump 13 and/or the monitoring of the high-pressure tank 15 can also be carried out by the control unit 17.

FIG. 2 shows a further embodiment of the preferred air-vapor engine 1.

In addition to the components already described in FIG. 1, a prechamber piston 27 is present inside the prechamber 9. The prechamber piston 27 is connected to the piston 5 of the cylinder such that the prechamber piston 27 can perform a stroke movement within the prechamber 9. Advantageously, the use of a prechamber piston 27 means that the volume of the vapor or air-vapor mixture is also displaced within the prechamber 9. As a result, the pressure of the vapor or air-vapor mixture in the prechamber 9 is also increased accordingly. By increasing the pressure within the prechamber 9, an intense pressure of the air-vapor mixture is transferred into the cylinder 3, which increases the overall performance of the air-vapor engine 1.

FIG. 3 illustrates a further embodiment of the preferred air-vapor engine 1.

This shows substantially the embodiment in FIG. 2, but the prechamber piston exhibits a drive 29. The drive 29 can be mechanical or electromagnetic. The prechamber piston can perform a lateral movement. An inlet and outlet valve 19 can also be provided here, such that the air-vapor mixture can be dosed even more precisely.

Advantageously, the volume displacement of the vapor or air-vapor mixture in the prechamber 9 can be configured particularly easily and precisely by means of the drive 29. This advantageously results in variability with regard to the possible selection and adjustment of the pressure within the prechamber 9, such that a stroke movement of the prechamber piston 27 can be performed particularly efficiently.

FIG. 4 schematically shows a further embodiment of the preferred air-vapor engine 1.

A pressure sensor 33 and a temperature sensor 35 are attached to the prechamber 9. The pressure sensor 33 and the temperature sensor 35 can exhibit a data connection to the control unit 17, such that components (in combination or individually or a selection of components) such as the laser 31, the inlet and outlet valve 19, the high-pressure pump 13 and/or the high-pressure tank 15 are advantageously operated taking into account the pressure and temperature values within the prechamber 9.

FIG. 5 shows an embodiment of the air-vapor engine 1.

In the embodiment according to FIG. 5, the air-vapor engine 1 also exhibits a laser 31, wherein the prechamber 9 is connected to the cylinder 3 via an inlet and outlet valve 19 (as a control valve). Here, the effects of both the inlet and outlet valve 19 and the laser 31 can be used advantageously to achieve a synergistic effect.

FIG. 6 shows a further embodiment of the air-vapor engine 1.

A laser 31 is also shown here, wherein the prechamber 9 is present as such and no other components are used. An extremely fast phase transformation of the fuel fluid is still advantageously ensured in the prechamber 9.

FIG. 7 shows a further embodiment of the air-vapor engine 1.

In this case, the air-vapor engine 1 exhibits a piston chamber 37 in the piston 5. In this case, the prechamber 9 is omitted and the formation and generation of vapor is shifted to the piston chamber 37. The advantage of this variant is direct vapor formation in the cylinder chamber and the cost savings of the inlet and outlet valve 19, the drive of the prechamber piston 27, the drive 29 and the laser 31. With this variant, all existing combustion engines could be converted easily and cost-effectively.

### Reference List

1 Air-vapor engine
3 Cylinder
5 Piston
7 Injection nozzle
9 Prechamber
11 Condenser
13 High-pressure pump
15 High-pressure tank
17 Control unit
19 Inlet and outlet valve
21 Inlet valve
23 Outlet valve
25 Connecting rod
27 Prechamber piston
29 Drive for prechamber piston
31 Laser
33 Pressure sensor
35 Temperature sensor
37 Piston chamber

1. An air-vapor engine (1) comprising a cylinder (3) and a piston (5), wherein a stroke movement between a top dead center and a bottom dead center can be executed by the piston (5) within the cylinder (3),
characterized in that
the air-vapor engine (1) exhibits an injection nozzle (7) and a prechamber (9) and/or piston chamber (37), wherein the prechamber (9) and/or piston chamber (37) are present between the injection nozzle (7) and the cylinder (3) in a flow connection and a fuel fluid can be introduced from the injection nozzle (7) into the prechamber (9) and/or piston chamber (37) and the fuel fluid can be converted into a vapor in the prechamber (9) and/or piston chamber (37)
and compressed air can be received from the cylinder (3) into the prechamber (9), such that an air-vapor mixture is formed within the prechamber (9) and the air-vapor mixture can be introduced into the cylinder (3), such that the stroke movement of the piston (5) can be performed within the cylinder (3)
and the cylinder (3) is connected to a condenser (11) in a flow connection and the cylinder (3) and the condenser (11) are connected to the injection nozzle (7) and the prechamber (9) in a circuit via a high-pressure pump (13) and a high-pressure tank (15), wherein the air-vapor mixture or the vapor of the air-vapor mixture can be introduced from the cylinder (3) into the condenser (11) and is present in the condenser (11) as condensate and the condensate can be introduced into the injection nozzle (7) via the high-pressure pump (13) and the high-pressure tank (15).

2. The air-vapor engine (1) according to the preceding claim claim 1
characterized in that
the condenser (11), the high-pressure pump (13), the high-pressure tank (15) and/or the injection nozzle (7) are data-connected to a control unit (17).

3. The air-vapor engine (1) according to claim 1
characterized in that
the air-vapor engine (1) exhibits a pressure sensor (33) and/or a temperature sensor (35), wherein the pressure sensor (33) and/or the temperature sensor (35) are preferably data-connected to a control unit (17).

4. The air-vapor engine (1) according to claim 1
characterized in that
a prechamber piston (27) is present within the prechamber (9), wherein the prechamber piston (27) is connected to the piston (5) in the cylinder (3), such that a stroke movement can be performed by the prechamber piston (27) within the prechamber (9), as a result of which a higher pressure and a higher temperature can be generated in the prechamber (9).

5. The air-vapor engine (1) according to claim 1
characterized in that
the prechamber piston (27) exhibits a drive (29).

6. The air-vapor engine (1) according to claim 1
characterized in that
the fuel fluid is selected from a group comprising water and/or carbon dioxide and/or other suitable fluids.

7. The air-vapor engine (1) according to claim 1
characterized in that
the prechamber (9) is functionally connected to a heating element.

8. The air-vapor engine (1) according to claim 1
characterized in that
the high-pressure tank (15) is functionally connected to a heating element.

9. The air-vapor engine (1) according to claim 1
characterized in that
the air-vapor engine (1) exhibits a laser (31), wherein it is possible to irradiate the prechamber (9) using the laser (31).

10. The air-vapor engine (1) according to claim 1
characterized in that
the air-vapor engine (1) exhibits a piston chamber (37).

11. The air-vapor engine (1) according to claim 1
characterized in that
the fuel fluid can be introduced into the prechamber (9) from the injection nozzle (7) at a pressure of between 2000 bar-3000 bar.

12. The air-vapor engine (1) according to claim 1
characterized in that
the compressed air from the cylinder (3) into the prechamber (9) exhibits a temperature between 500° C.-1000° C.

13. The air-vapor engine (1) according to claim 1
characterized in that
the air-vapor engine (1) can be operated using a four-stroke mechanism or a two-stroke mechanism.

14. Use of the air-vapor engine (1) according to claim 1 for converting energy into mechanical energy, preferably into kinetic energy within a means of locomotion.

15. Use of the air-vapor engine (1) according to claim 1 for operation of an air conditioning compressor.

16. The air-vapor Air-vapor engine (1) according to claim 2
characterized in that
the control unit is data-connected to further components, the further components are selected from a group consisting of: a laser (31), an inlet and outlet valve (19) and/or a drive (29) for the prechamber piston (27).

17. The air-vapor engine (1) according to claim 5
characterized in that
the drive (29) is operated mechanically or electromagnetically.

18. The air-vapor engine (1) according to claim 9
characterized in that
the prechamber (9) comprises a prechamber piston (27) for increasing the pressure and temperature in the prechamber (9) and/or a drive (29) for the prechamber piston (27).

19. The air-vapor engine (1) according to claim 12
characterized in that
the compressed air from the cylinder (3) into the prechamber (9) exhibits a temperature between 600° C.-900° C. and/or a pressure between 20 bar-80 bar.

20. The air-vapor engine (1) according to claim 12
characterized in that
after introduction of the fuel fluid into the prechamber (9) a pressure within the prechamber (9) increases and a temperature within the prechamber (9) decreases.
